(19) United States
(12) Patent Application Publication
(10) Pub. No.: US 2025/0209524 A1
(43) Pub. Date: Jun. 26, 2025

(54) REAL-TIME VISUALIZATION OF A VIRTUAL SCENE CONTROLLABLE THROUGH PHYSICAL OBJECTS

(71) Applicant: Wayfair LLC, Boston, MA (US)

(72) Inventors: Nicole Allison Tan, Brookline, MA (US); Abhijit Gurjal, Cambridge, MA (US); Shrenik Sadalgi, Cambridge, MA (US)

(21) Appl. No.: 18/847,917

(22) PCT Filed: Apr. 5, 2023
(86) PCT No.: PCT/US2023/017567

§ 371 Date: Sep. 17, 2024

Related U.S. Application Data
(60) Provisional application No. 63/390,873, filed on Jul. 20, 2022.
(60) Provisional application No. 63/327,669, filed on Apr. 5, 2022.

(51) Int. Cl. G06Q 30/0601; G06T 7/70; G06T 13/40; G06T 15/06

(52) U.S. Cl. CPC G06Q 30/0643; G06T 7/70; G06T 13/40; G06T 15/06

(57) ABSTRACT

Method and systems for visualizing product(s) in a virtual scene are provided. A first product is visualized in the virtual scene by obtaining, from a sensing platform having positioned thereon a first physical object representing the first product, a first pose of the first physical object and a first identifier of the first product; identifying, using the first identifier and from among a plurality of three-dimensional (3D) models corresponding to a respective plurality of products, a first 3D model corresponding to the first product; generating a visualization of product(s) in the virtual scene at least in part by: generating, at a position and orientation in the virtual scene determined from the first pose of the first physical object, a visualization of the first product using the first 3D model of the first product; and providing the visualization to a display device for displaying the visualization.

### CROSS-REFERENCE TO RELATED APPLICATIONS

This application claims the benefit of priority under 35 U.S.C. 119(e) to U.S. Provisional Patent Application Ser. No. 63/390,873, filed on Jul. 20, 2022, titled “Real-time visualization of a room controllable through physical miniatures”, and U.S. Provisional Patent Application Ser. No. 63/327,669, filed on Apr. 5, 2022, titled “Real-time visualization of a room controllable through physical miniatures,” which are hereby incorporated by reference herein in their entirety.

### BACKGROUND

Online retailers primarily sell products (e.g., furniture, toys, clothing, and electronics) through an online computer interface (e.g., a website). A customer can access the online computer interface to view images of products and place orders to have the products delivered to their home. Customers of online retailers, however, are increasingly demanding to see products in person prior to purchase. Accordingly, some online retailers have established brick-and-mortar stores where customers can interact with products in-person prior to purchase.

### SUMMARY

Some embodiments provide for a method for visualizing one or more products in a virtual scene, the one or more products including a first product. The method comprises: obtaining, from a sensing platform having positioned thereon a first physical object representing the first product, a first pose of the first physical object on the sensing platform and a first identifier of the first product; identifying, using the first identifier and from among a plurality of three-dimensional (3D) models corresponding to a respective plurality of products, a first 3D model corresponding to the first product; generating a visualization of the one or more products in the virtual scene at least in part by: generating, at a position and orientation in the virtual scene determined from the first pose of the first physical object, a visualization of the first product using the first 3D model of the first product; and providing the visualization to a display device for displaying the visualization.

Some embodiments provide for a system visualizing one or more products in a virtual scene, the one or more products including a first product. The system comprises: at least one computer hardware processor; and at least one non-transitory computer-readable storage medium storing processor executable instructions that, when executed by the at least one computer hardware processor, cause the at least one computer hardware processor to perform a method comprising obtaining, from a sensing platform having positioned thereon a first physical object representing the first product, a first pose of the first physical object on the sensing platform and a first identifier of the first product; identifying, using the first identifier and from among a plurality of three-dimensional (3D) models corresponding to a respective plurality of products, a first 3D model corresponding to the first product; generating a visualization of the one or more products in the virtual scene at least in part by: generating, at a position and orientation in the virtual scene determined from the first pose of the first physical object, a visualization of the first product using the first 3D model of the first product; and providing the visualization to a display device for displaying the visualization.

Some embodiments provide for at least one non-transitory computer-readable storage medium storing processor-executable instructions that, when executed by at least one computer hardware processor, cause the at least one computer hardware processor to perform a method comprising obtaining, from a sensing platform having positioned thereon a first physical object representing the first product, a first pose of the first physical object on the sensing platform and a first identifier of the first product; identifying, using the first identifier and from among a plurality of three-dimensional (3D) models corresponding to a respective plurality of products, a first 3D model corresponding to the first product; generating a visualization of the one or more products in the virtual scene at least in part by: generating, at a position and orientation in the virtual scene determined from the first pose of the first physical object, a visualization of the first product using the first 3D model of the first product; and providing the visualization to a display device for displaying the visualization.

Some embodiments provide for a system for visualizing one or more products in a virtual scene, the one or more products including a first product. The system comprises: a sensing platform having positioned thereon a first physical object representing the first product; at least one computer hardware processor configured to: obtain, from the sensing platform, a first pose of the first physical object on the sensing platform and a first identifier of the first product; identify, using the first identifier and from among a plurality of three-dimensional (3D) models corresponding to a respective plurality of products, a first 3D model of the first product; generate a visualization of the one or more products in the virtual scene at least in part by: generating, at a position and orientation in the virtual scene determined from the first pose of the first physical object, a visualization of the first product using the first 3D model of the first product; and provide the visualization to a display device; and the display device configured to display the visualization.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 is an example system for visualizing products in a virtual scene, according to some embodiments of the technology described herein;

FIG. 2A illustrates an example diagram showing a sensing platform and a display device displaying a visualization of a first set of products in a virtual scene, according to some embodiments of the technology described herein;

FIG. 2B illustrates an example diagram showing the sensing platform and the display device displaying a visualization of a second set of products in the virtual scene, according to some embodiments of the technology described herein;

FIG. 2C illustrates an example diagram showing the sensing platform and the display device displaying a visualization of a third set of products in the virtual scene, according to some embodiments of the technology described herein;

FIG. 2D illustrates example physical objects positioned on a translucent surface of a sensing platform, according to some embodiments of the technology described herein;

FIG. 3A illustrates visualizations of products in a virtual scene from different perspectives, according to some embodiments of the technology described herein;

FIG. 3B illustrates visualizations of products in different lighting conditions, according to some embodiments of the technology described herein;

FIG. 4A illustrates an example sensing platform on the left and an example virtual scene generated by the system described herein on the right, according to some embodiments of the technology described herein;

FIG. 4B illustrates an example physical three-dimensional (3D) model of a product positioned on the sensing platform and an example visualization of the product in a virtual scene, according to some embodiments of the technology described herein;

FIG. 4C illustrates example manipulations of the physical 3D model on the sensing platform and corresponding updated visualizations of the product in the virtual scene, according to some embodiments of the technology described herein;

FIG. 4D illustrates an example arrangement of physical 3D models of products on the sensing platform and an example visualization of the products in the virtual scene, according to some embodiments of the technology described herein;

FIG. 4E illustrates another example arrangement of physical 3D models of products on the sensing platform and an example visualization of the products in the virtual scene, according to some embodiments of the technology described herein;

FIGS. 5A-5B illustrate example visualizations of products from different perspectives, according to some embodiments of the technology described herein;

FIG. 6 is flowchart of an example process for visualizing products in a virtual scene, according to some embodiments of the technology described herein;

FIG. 7 is a block diagram of an example computer system, according to some embodiments of the technology described herein.

### DETAILED DESCRIPTION

Some online retailers have established brick-and-mortar stores to enable customers to view various products in-person prior to purchase. The inventors have appreciated that online retailers typically offer a wider range of products than brick-and-mortar only retailers. For example, an online retailer may offer in excess of 1 million different products while a brick-and-mortar only retailer in the same market segment may only offer 15,000 products. As a result, the conventional approach of displaying all of an online retailer's product offerings in a single store would require a brick-and-mortar store of considerable size. The size requirement is further exacerbated when the products being sold are large, such as pieces of furniture, and there are many variations of the same product (e.g., color, size, and/or material). Therefore, an online retailer displays only some of the products in its brick-and-mortar store and keeps even fewer products in stock.

A customer browsing for a product at a brick-and-mortar store, such as a piece of furniture, may not find a desired configuration (e.g., color, size, shape, material, etc.) displayed in the store. In some cases, the customer may find a product displayed in the store, but a desired configuration of the product may be out of stock. Also, when browsing for products, customers may wish to browse a larger collection rather than the few items displayed in the store. Brick-and-motor stores with limited retail floor space are unable to meet the increasing demands of customers.

Existing digital content creation (DCC) tools enable customers to interact with a variety of products via an online computer interface. These systems typically utilize three-dimensional (3D) modeling and rendering technology to generate 3D models of the products and display the 3D models to the customer. The inventors have appreciated that customers typically do not have expert knowledge in navigating these complex systems and hence installing such systems in a brick-and-mortar store would be unfavorable.

The inventors have recognized that to enable customers to interact with an online retailer's catalog of product offerings in a brick-and-mortar store, an intuitive and easy-to-use system that requires little or no prior training is needed. To this end, the inventors have developed a system that enables customers to explore a large catalog by generating visualizations of products(s) in virtual scene(s) in real-time at the brick-and-mortar store. A visualization of a product may be a computer-generated visual representation of a 3D model of the product. A virtual scene may be any suitable scene into which visualizations of products may be placed. For example, a virtual scene may be a computer-generated visual representation of a room (e.g., a bedroom, kitchen, or other room in a home; an office space in an office building, and/or any other room in any other type of property). As another example, a virtual scene may be an augmented reality (AR) representation, whereby the visualizations of the products are overlaid onto one or more images of a physical scene. Such an AR representation may be displayed using one or more AR-capable devices. As yet another example, the virtual scene may be a virtual reality (VR) representation and may be displayed using one or more VR-capable devices.

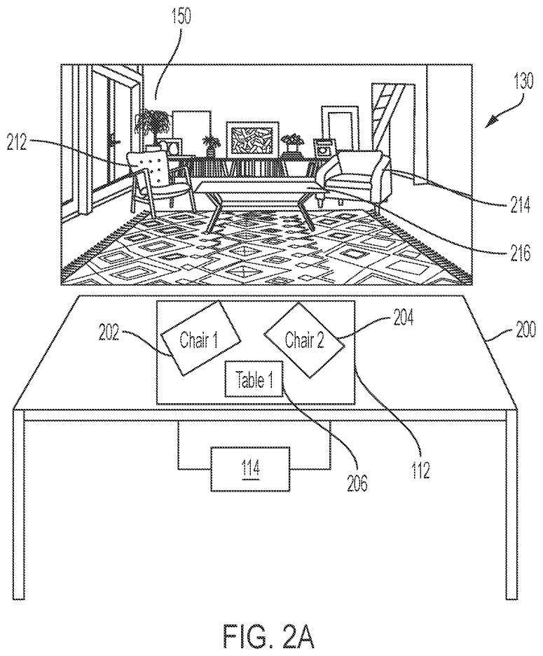

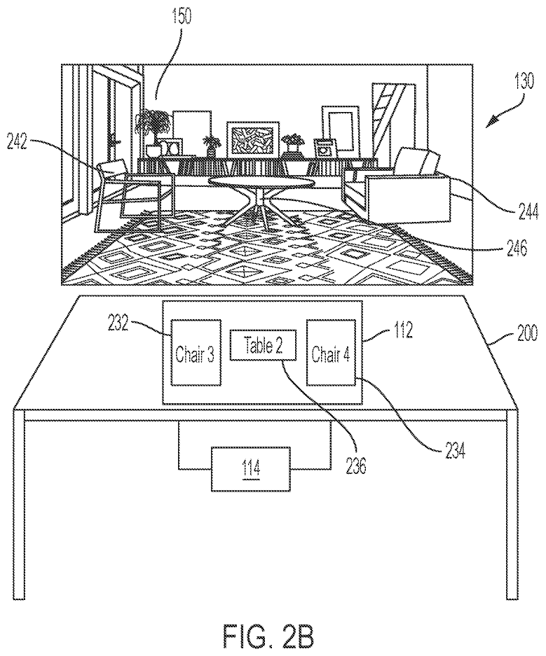

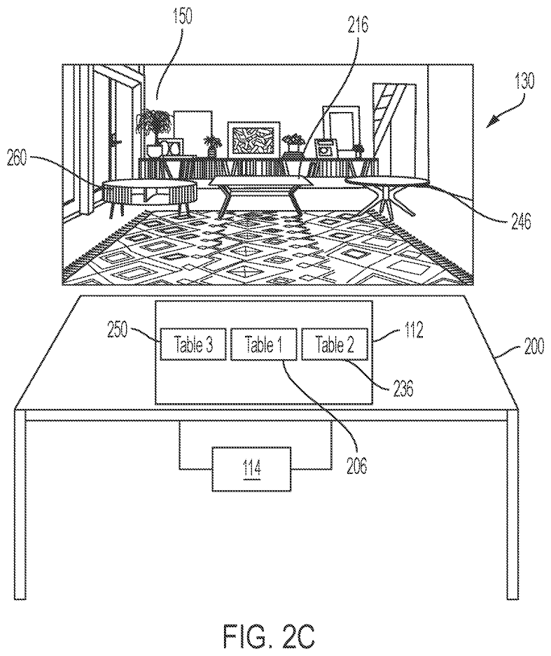

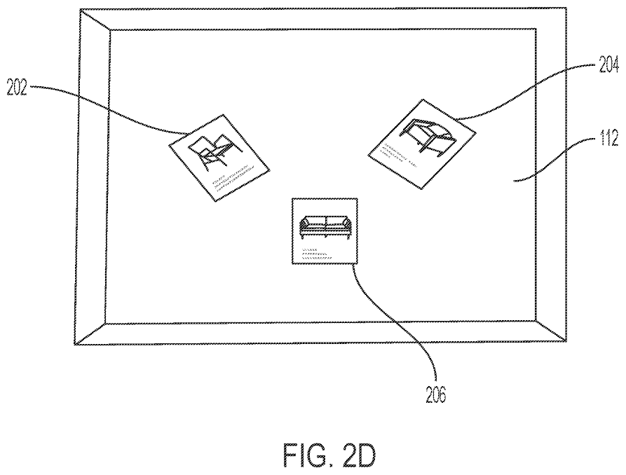

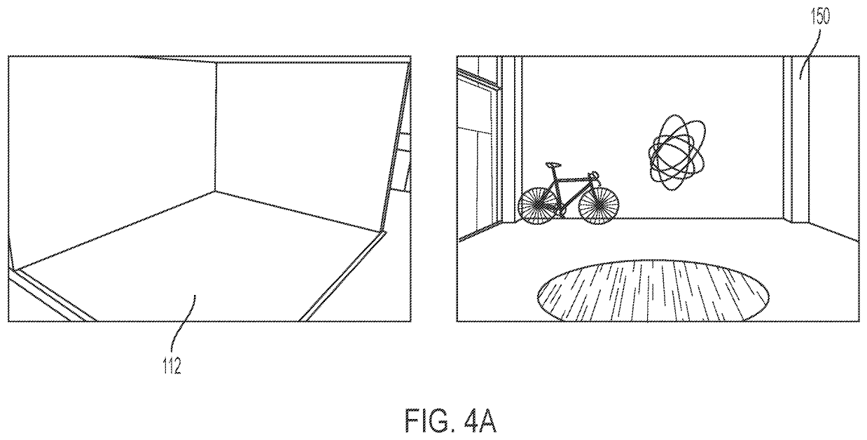

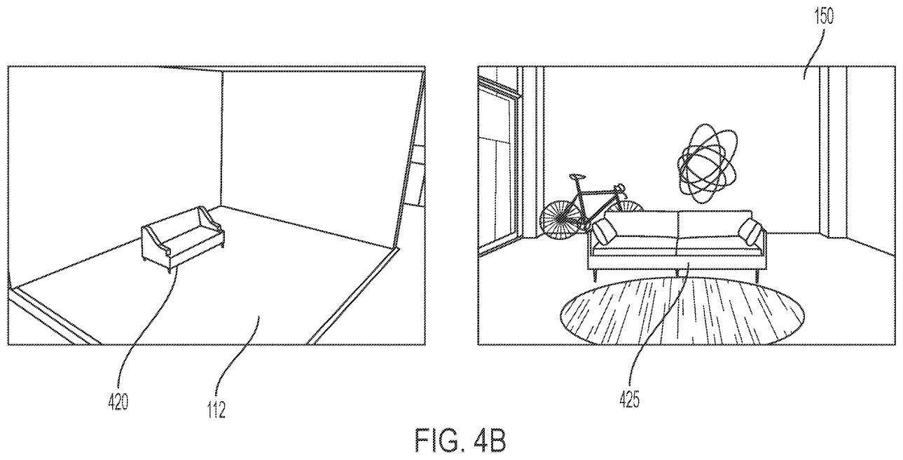

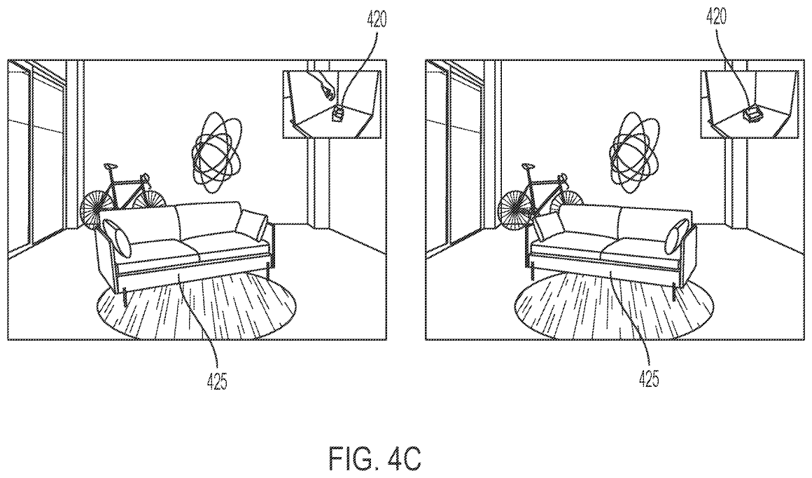

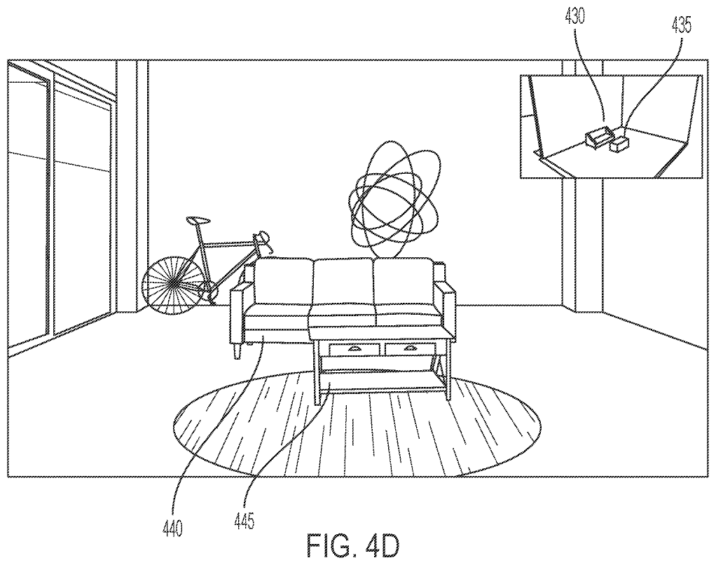

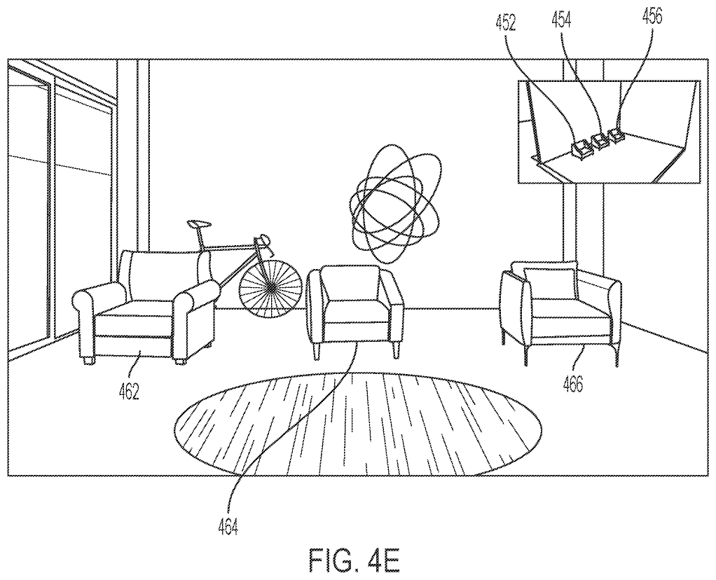

The visualizations of products in a virtual scene are generated based on manipulation of physical objects placed on a sensing platform, where the physical objects represent the products. Examples of a physical object representing a product may include, but not be limited to, a physical 3D model of the product (e.g., physical 3D model 420 shown in FIG. 4B), a card having an image of the product thereon (e.g., product card 202 shown in FIG. 2D), and a swatch of a material having the image of the product thereon.

Poses of the physical objects on the sensing platform are determined and a visualization of the products (corresponding to the physical objects on the sensing platform) in the virtual scene is generated by positioning and orienting 3D models of the products in the virtual scene based on the determined poses. The virtual scene including the generated visualizations of the products is rendered via a ray tracing technique in real-time. This output is displayed on a large display. In this way, customers who shop at a brick-and-mortar store can explore a large catalog by creating inspirational images that are indistinguishable from reality. The system developed by the inventors provides an interactive real-time ray traced experience based on spatially manipulating physical objects (e.g., product cards) to view virtual furniture arrangements at photorealistic quality on a large format display. Physical objects on a sensing platform serve as tangible user interfaces that make it easier for non-expert customers to control 3D digital content creation tools that generate the visualizations of the products.

In some embodiments, a method of visualizing one or more products in a virtual scene (e.g., virtual scene 150 shown in FIG. 2A) is provided where the one or more products includes a first product (e.g., furniture, art, or other product) and at least one computer hardware processor is used to perform: (1) obtaining, from a sensing platform (e.g., sensing platform 110 including a table 200) having positioned thereon a first physical object representing the first product (e.g., card 202 representing a chair), a first pose of the first physical object on the sensing platform and a first identifier of the first product; (2) identifying, using the first identifier and from among a plurality of three-dimensional (3D) models corresponding to a respective plurality of products, a first 3D model corresponding to the first product; (3) generating a visualization of the one or more products in the virtual scene at least in part by: generating, at a position and orientation in the virtual scene determined from the first pose of the first physical object, a visualization of the first product using the first 3D model of the first product (e.g., visualization 212 of the chair represented by card 202); and (4) providing the visualization to a display device for displaying the visualization (e.g., display device 130).

In some embodiments, the first physical object has a marker (e.g., an ArUco marker and/or QR code) on its surface and the method further comprises detecting the marker on the surface of the first physical object, and determining, using the marker, the first pose of the first physical object and the first identifier of the first product.

In some embodiments, the one or more products comprise multiple products, the multiple products including the first product, and the method comprises: (1) obtaining, from the sensing platform having positioned thereon multiple physical objects (e.g., cards 202, 204, and 206 shown in FIG. 2A; cards 232, 234, and 236 shown in FIG. 2B; or cards 250, 206, and 236 shown in FIG. 2C) representing the multiple products, poses of the physical objects on the sensing platform and identifiers of the multiple products, the poses including the first pose of the first physical object and the identifiers including the first identifier; (2) identifying 3D models of the multiple products using the identifiers; and (3) generating the visualization of the one or more products in the virtual scene at least in part by generating, at positions and orientations in the virtual scene determined from the poses of the physical objects, visualizations of the multiple products using the 3D models of the multiple products (e.g., visualizations 212, 214, and 216 shown in FIG. 2A; visualizations 242, 244, and 246 shown in FIG. 2B; or visualizations 260, 216, and 246 shown in FIG. 2C). In this way, multiple arrangements of products can be visualized in a virtual scene by manipulation of physical objects representing the products, such as product cards, on the sensing platform. The system developed by the inventors enables presentation of an online retailer's large catalog in a brick-and-mortar store by generating rich interactive visualizations that instill confidence in prospective customers and improve their shopping experience.

In some embodiments, the method further comprises detecting markers on surfaces of the physical objects; and determining, using the markers, the poses of the physical objects on the sensing platform and the identifiers of the multiple products.

In some embodiments, the method further comprises displaying the generated visualization of the one or more products in the virtual scene using the display device.

In some embodiments, the first physical object is a physical 3D model of the first product (e.g., physical 3D model 420 of a couch shown in FIG. 4B). In some embodiments, the first physical object has an image of the first product thereon (e.g., product card 202 having an image of a chair as shown in FIG. 2D). In some embodiments, the first physical object is a card or a swatch of material.

In some embodiments, the method comprises rendering the generated visualization of the one or more products in the virtual scene using a ray tracing technique.

In some embodiments, a system (e.g., system 100) for visualizing one or more products in a virtual scene is provided, where the one or more products includes a first product and the system comprise: (1) a sensing platform (e.g., sensing platform 110) having positioned thereon a first physical object representing the first product; (2) at least one computer hardware processor (e.g., processor 116 or processor 126) configured to: (a) obtain, from the sensing platform, a first pose of the first physical object on the sensing platform and a first identifier of the first product; (b) identify, using the first identifier and from among a plurality of 3D models corresponding to a respective plurality of products, a first 3D model of the first product; (c) generate a visualization of the one or more products in the virtual scene at least in part by generating, at a position and orientation in the virtual scene determined from the first pose of the first physical object, a visualization of the first product using the first 3D model of the first product; and (d) provide the visualization to a display device; and (3) the display device (e.g., display device 130) configured to display the visualization.

In some embodiments, the sensing platform comprises a translucent surface (e.g., translucent surface 112) on which the first physical object representing the first product is positioned; and an imaging device (e.g., imaging device 114) placed in proximity to the translucent surface. Examples of an imaging device may include, but not be limited to, a camera, an arrangement of one or more light sources and one or more photodetectors, an arrangement of one or more radiation sources (e.g., scanners or other sources that radiate light) and one or more photodetectors, and an arrangement of optical members such as one or more mirrors or reflectors, one or more light or radiation sources, and/or one or more photodetectors. For example, FIGS. 2A-2C depict an imaging device, such as a camera, placed under the translucent surface. In other arrangements, at least one optical member of the imaging device (e.g., a mirror) may be placed under the translucent surface and another optical member (e.g., a photodetector) may be placed at a different location but in proximity to the translucent surface. Other suitable arrangements of optical members may be used without departing from the scope of this disclosure.

In some embodiments, the first physical object has a marker on its surface, and the camera is configured to capture at least one image of the marker.

In some embodiments, the at least one computer hardware processor is part of the sensing platform. In some embodiments, the at least one computer hardware processor is remote from the sensing platform (e.g., part of server computing device 120).

In some embodiments, the first physical object is a physical 3D model of the first product, a card having an image of the first product thereon, or a swatch of a material having the image of the first product thereon.

In some embodiments, the display device comprises a projector and a screen.

Following below are more detailed descriptions of various concepts related to, and embodiments of, methods and systems for visualizing product(s) in virtual scene(s). It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

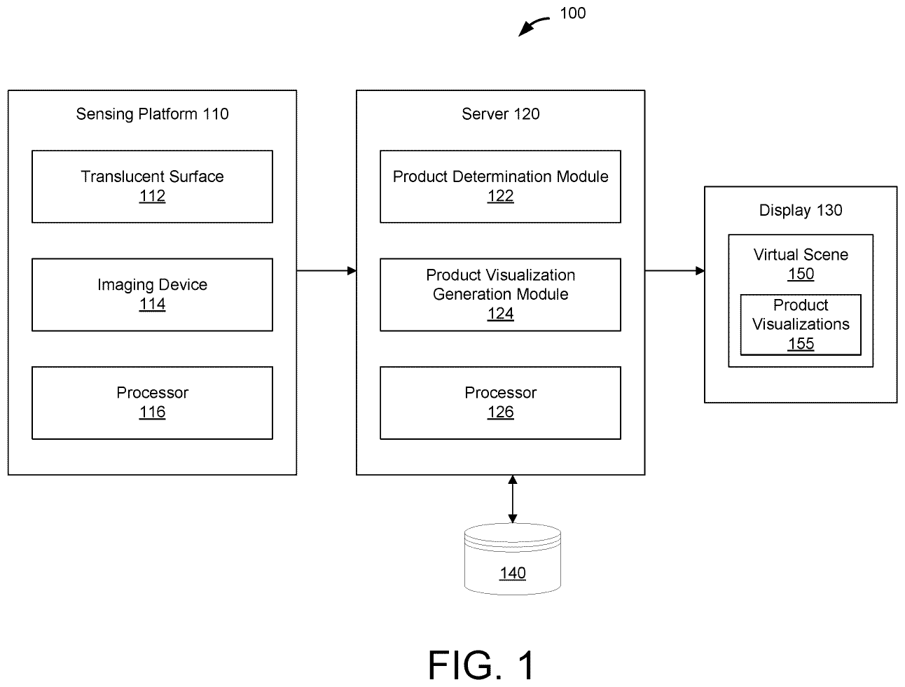

FIG. 1 illustrates components of a system 100 for visualizing product(s) in a virtual scene in accordance with some embodiments of the technology described herein. System 100 includes a sensing platform 110, a server computing device 120, and a display device 130. Sensing platform 110 is configured to determine poses of physical objects placed thereon where the physical objects represent products from an online retailer's catalog. Server computing device 120 is configured to receive the poses of the physical objects and generate a visualization of the products in the virtual scene by positioning and orienting 3D models corresponding to the products in the virtual scene based on the determined poses. Display device 130 is configured to display the generated visualization of the products in the virtual scene.

In some embodiments, the sensing platform 110 includes a translucent surface 112, an imaging device 114, and at least one processor 116. In some embodiments, the translucent surface 112 may be provided on any suitable structure of a suitable height. For example, as shown in FIGS. 2A-2C, the translucent surface 112 is provided on a table 200. In some embodiments, a rectangular or other shaped portion of the top of the table 200 may be cutout to accommodate the translucent surface 112. The translucent surface may include a translucent polycarbonate pane or other translucent surface. In some embodiments, a glass table or a table including a transparent surface may be used instead of the translucent surface without departing from the scope of this disclosure.

In some embodiments, the imaging device 114 may be placed in proximity to the translucent surface 112. For example, the imaging device 114 may include a camera that is placed under the translucent surface 112, as shown in FIGS. 2A-2C. The camera may be a digital camera, such as a webcam or camera of a mobile device, which captures digital images and/or video. In some embodiments, the camera is positioned such that the lens of camera points upwards at the translucent surface 112. Any suitable imaging device 114 capable of capturing images and/or video may be used without departing from the scope of this disclosure. In another embodiment, one or more mirror(s) may be placed under the translucent surface 112 and may reflect light to an imaging device (e.g., a camera, a photodetector, etc.).

In some embodiments, one or more physical objects representing respective one or more products are positioned on the translucent surface 112 of the sensing platform 110. Each physical object positioned on the sensing platform has a unique marker on its surface. In some embodiments, the marker is provided on a bottom surface of the physical object. The physical object is placed on the translucent surface 112 with the marker facing down and therefore visible to at least one optical member of the imaging device 114. As shown in FIGS. 2A-2C, a physical object may be a card. In some embodiments, as shown in FIG. 2D, the card may have an image of the product it represents thereon. In some embodiments, the image of the product may be attached to the card or printed on the card. In some embodiments, the card may have additional information regarding the product thereon, such as name and brief description of the product. In some embodiments, as shown in FIGS. 4B-4E, a physical object may be a physical 3D model of the product it represents. In some embodiments, a physical object may be a swatch of a material having an image of the product it represents thereon. Other types of physical objects, such as those that do not resemble the product, may be used without departing from the scope of this disclosure.

In some embodiments, a marker provided on the surface of a physical object comprises an ArUco marker. An ArUco marker is a binary square fiducial marker that supports identification of the marker and determination of a pose (e.g., a 6-degrees of freedom (DOF) pose) of the physical object. An ArUco marker includes a black border and an inner white pattern representing a binary code that identifies the marker. Any suitable ArUco marker may be used, such as those described in article titled “Automatic generation and detection of highly reliable fiducial markers under occlusion,” by S. Garrido-Jurado and Rafael Munoz-Salinas (June 2014; Pattern Recognition 47(6):2280-2292), which is incorporated by reference herein in its entirety. It will be appreciated that any other suitable type of marker that supports identification of the marker and determination of a pose of the physical object, such as a QR code, may be used without departing from the scope of this disclosure.

The imaging device 114 captures image(s) and/or video of markers on surfaces of one or more physical objects positioned on the sensing platform. In some embodiments, the processor 116 processes the image(s) and/or frame(s) of the captured video to detect the markers and determine the poses of corresponding physical objects using the detected markers.

In some embodiments, marker detection and pose determination may be performed using any suitable computer vision and/or object detection technique. In some embodiments, the marker detection process may identify, for each detected marker, corners of the detected marker and an identifier of the detected marker. A list of corners of the detected marker may be generated that includes the four corners of the detected marker in their original order, which is clockwise starting with top left corner. Thus, the list of corners includes the top left corner, followed by the top right corner, then the bottom right corner, and finally the bottom left corner. The list of corners may include a list containing coordinates (such as, x and y coordinates) of the corners of the detected marker.

In some embodiments, for each detected marker, a pose of a corresponding physical object (e.g., a position and/or orientation of the physical object) may be determined. A pose of the physical object may be determined using the detected marker. In some embodiments, information regarding the corners of the detected marker may be used to determine the pose of the corresponding physical object. In some embodiments, information regarding the corners of the detected marker and one or more parameters associated with imaging device 114 may be used to determine the pose of the corresponding physical object. For example, one or more parameters associated with the imaging device 114, such as a camera, may include extrinsic and/or intrinsic parameters. Extrinsic parameters of the camera may include a location and orientation of the camera with respect to a 3D world coordinate system. Intrinsic parameters of the camera may include focal length, aperture, field of view, resolution and/or other parameters that allow mapping between camera coordinates and pixel coordinates in an image.

In some embodiments, to determine a pose of a physical object using a marker, such as an ArUco marker, the marker is detected using a suitable ArUco library, such as OpenCV's ArUco module. Using the information regarding the marker's corners and a known marker size, and the imaging device's parameters, the marker's 3D position and rotation (i.e., orientation) may be determined. The resulting output may include a rotation vector and a translation vector that describes the physical object's pose relative to the imaging device (e.g., a camera).

In some embodiments, the sensing platform 110 may communicate the identifiers of the detected markers and the determined poses of the corresponding physical objects to the server computing device 120. In some embodiments, the marker identifiers and determined poses may be serialized as a JSON string and the JSON string may be communicated via a network socket to the server computing device 120. The communication may take place at suitable intervals, such as once every second, once every two seconds, once every 3 seconds, or any other suitable interval. In some embodiments, Python or any other suitable programming language may be used to program sockets for client-server communication between the sensing platform 110 and the server computing device 120. In some embodiments, other network communication techniques, such as wireless communication techniques, may be used without departing from the scope of this disclosure.

In some embodiments, the server computing device 120 includes a product determination module 122, a product visualization generation module 124, and at least one processor 126 that is configured to perform various functions of the server computing device 120 and/or the modules 122, 124 described herein. In some embodiments, the product visualization generation module 124 may run a 3D DCC tool, such as 3DS Max or any other suitable computer graphics program or DCC tool. In some embodiments, the product visualization module may run a ray tracing program, such as Chaos Vantage or any other suitable ray tracing program.

In some embodiments, the server computing device 120 may obtain the marker identifiers and the determined poses of the corresponding physical objects from the sensing platform 110. In some embodiments, the product determination module 122 may extract the marker identifiers and the determined poses from the received JSON string.

In some embodiments, each marker identifier corresponds to a specific product in the online retailer's product catalog. Each marker identifier may correspond to product identifier, such as a SKU (stock keeping unit) number, for a specific product. Thus, the marker identifiers may also be referred to as product identifiers herein. In some embodiments, a product database 140 may store information about products listed in or available via an online product catalog. For each product, the product database 140 may include information about the product, such as, a name or reference number, a product identifier (e.g., SKU number), one or more images of the product, one or more 3D models of the product, product classification (e.g., desk, chair, couch, etc.), and/or feature classification, such as, color (e.g., black, while, red, multi-colored, etc.), texture (velvet, linen, etc.), size (e.g., width, height and depth information), material (e.g., wood, metal, paper, etc.), major theme or style (e.g., Gothic, Modern, French Country, etc.) and secondary theme or style (e.g., Minimalist, Farmhouse, Modern, etc.).

In some embodiments, the product determination module 122 may identify 3D models of multiple products using the marker identifiers obtained from the sensing platform 110. The product determination module 122 may compare the received marker identifiers with the product identifiers stored in the product database 140 to identify the products corresponding to the marker identifiers and the appropriate 3D models of the products. The product determination module 122 may identify 3D models of the multiple products from among a plurality of 3D models corresponding to a respective plurality of products in the product database 140. The product determination module 122 may retrieve the identified 3D models of the multiple products from the product database 140.

In some embodiments, the product visualization generation module 124 may generate visualizations 155 of the multiple products in a virtual scene 150. In some embodiments, a virtual scene may be automatically selected by the product visualization generation module 124. In some embodiments, a user, such as a customer, may be prompted to select a desired virtual scene. For example, a customer may be allowed to select, via an input device or user interface associated with the sensing platform 110 or system 100, a particular virtual scene from among a plurality of virtual scene options. As another example, a customer may be allowed to upload an image or scan of their own space as the virtual scene. For example, a customer may provide one or more images and/or scans of one or more rooms in their home to use for generating the virtual scene. This may be helpful if the customer is attempting to visualize one or more products (e.g., furniture, accessories, etc.) in their home. This may be achieved in any suitable way. For example, a customer may bring a USB key (or any other type of computer readable storage medium) with images on it and transfer those images to the system 100. As another example, the customer could provide input to system 100 which would allow the system 100 to obtain the image(s) and/or scan(s) from a remote source. For example, the customer may provide a URL to a website from where the image(s) and/or scan(s) may be downloaded. As another example, the customer may upload the image(s) and/or scan(s) using a software application (“App”) installed on a mobile device, such as, the customer's mobile smartphone, tablet computer, laptop computer or other mobile device. For example, the customer may bring image(s) and/or scan(s) via the App and the load the image(s) and/or scan(s) via a QR code shown on the App.

In some embodiments, the product visualization generation module 124 may generate visualizations of the multiple products in the virtual scene. In some embodiments, a visualization of a product may be computer-generated visual representation of the 3D model of the product. The visual representation may comprise an image, an animation, or a video. In some embodiments, the visualization of the product may include a textured visual representation of the 3D model of the product. The textured visual representation of the 3D model may be generated by applying an appropriate texture or material corresponding to a particular variant of the product to the visual representation of the 3D model. For example, a physical object placed on the sensing platform may correspond to a blue leather couch. The marker identifier may correspond to the SKU number of this variant of the couch. To generate a visualization of the couch, the product visualization generation module 124 may retrieve a 3D model of the couch (without the color or material features) from the product database 140 and apply the “blue” color and “leather” texture to the 3D model. In some embodiments, the product database 140 may store texture models corresponding to different textures and the appropriate texture model may be retrieved to generate the textured visual representation of the 3D model of the product.

In some embodiments, the visualizations of the products may be generated using the poses of the corresponding physical objects obtained from the sensing platform 110. The product visualization generation module 124 may generate the visualizations at least in part by generating, at positions and orientations in the virtual scene determined from the poses of the physical objects, visualizations of the multiple products using the 3D models of the multiple products.

In some embodiments, the product visualization generation module 124 may receive a pose of a physical object placed on a sensing platform, generate a visualization of a product represented by the physical object using the 3D model of the product, and place the generated visualization of the product in the virtual scene at a position and orientation in the virtual scene determined from the pose of the physical object. In some embodiments, placing the generated visualization of the product in the virtual scene may include applying one or more transformations to the generated visualization based on the translation and rotation vectors describing the pose of the physical object. In some embodiments, the product visualization generation module 124 may perform these acts for each physical object placed on the sensing platform. In some embodiments, determined poses of the physical objects may be used to position the camera and corresponding product visualizations in 3DS Max in the virtual scene.

In some embodiments, the generated visualizations of the products 155 in the virtual scene 150 may be provided to a display device 130 for displaying the visualizations. The display device 130 may include a projector and a screen. Examples of a display device may include but not be limited to a plasma display, a DLP projector, an LCD projector, a flexible display, and/or other devices.

In some embodiments, the virtual scene including the generated visualizations of the products is input to a ray tracing program that renders the virtual scene. The ray tracing program streams any changes (e.g., geometry changes) made to the visualizations/virtual scene and renders the changes in real-time. The ray tracing program renders the staged virtual scene using physically based cameras, lights, materials, and global illumination. The ray tracing program generates a photorealistic image of the virtual scene, which is output to the display device 130. In some embodiments, the display device 120 comprises a large display, such as a projector screen or a large format display, which enables the output to be displayed at life-sized scale so that customers can get an accurate sense of the size of the product.

FIGS. 2A-2C illustrates example visualizations of products in a virtual scene generated based on manipulation of different sets of physical objects, such as product cards, placed on a sensing platform, according to some embodiments of the technology described herein. As shown in FIG. 2A, cards 202, 204, 206 representing specific furniture products are positioned on translucent surface 112 provided on a table 200. Imaging device 114, such as a camera, is placed under the translucent surface 112. Each card 202, 204, 206 has a marker on its surface (e.g., its bottom surface). The cards 202, 204, 206 are placed on the translucent surface 112 of the table 200 with the markers facing down and therefore visible to the imaging device 114. Images from the imaging device 114 are processed to detect the markers.

In some embodiments, the markers identify the respective products. For example, a marker on the bottom surface of card 202 identifies the product “Chair 1”, a marker on the bottom surface of card 204 identifies the product “Chair 2”, and a marker on the bottom surface of card 206 identifies the product “Table 1”. In some embodiments, the marker identifiers correspond to the respective product identifiers (e.g., SKU numbers). In some embodiments, the marker/product identifiers and poses of the cards 202, 204, 206 are determined using the respective detected markers. Using the marker/product identifiers, the 3D models of the products “Chair 1”, “Chair 2” and “Table 1” are identified. Visualizations 212, 214, 216 of the products are generated in a virtual scene 150 based on the poses of the cards 202, 204, 206. The visualizations 212, 214, 216 are displayed via a display device 130.

As shown in FIG. 2B, a different set of cards 232, 234, 236 are positioned on the translucent surface 112. Visualizations 242, 244, 246 of the products represented by the cards 232, 234, 236 are generated in the virtual scene and displayed via display device 130. As can be seen, the poses of cards 232, 234, 236 are different from the cards 202, 204, 206, which results in a different arrangement of products being displayed via display device 130. FIG. 2C shows yet another different set of cards 250, 206, 236 positioned on the translucent surface 112 and appropriate visualizations 260, 216, 246 of products represented by the cards being displayed via display device 120.

FIGS. 4A-4E illustrate example visualizations of products in a virtual scene generated based on manipulation of physical objects, such as physical 3D models of the products, placed on a sensing platform, according to some embodiments of the technology described herein. FIG. 4A shows an example translucent surface 112 of a sensing platform 110 on the left and a virtual scene 150 on the right. FIG. 4B shows a physical 3D model of a couch 420 placed on translucent surface 112. An identifier of the couch and a pose of the physical 3D model may be determined using a marker placed on a bottom surface of the physical 3D model. The couch identifier may be used to identify a 3D model of the couch from the product database 140. A visualization of the couch 425 in the virtual scene may be generated by generating, at a position and orientation in the virtual scene determined from the pose of the physical 3D model, a visualization of the couch using the 3D model of the couch retrieved from the product database 140. FIG. 4C illustrates how manipulation of the physical 3D model 420 on the translucent surface (e.g., changes to orientation) causes corresponding changes to the product visualizations 425 in the virtual scene. FIG. 4D illustrates a physical 3D model of a couch 430 and physical 3D model of a table 435 placed on translucent surface 112 and product visualizations 440, 445 corresponding to the products generated in the virtual scene. FIG. 4E illustrates physical 3D models of three chairs 452, 454, 456 placed on translucent surface 112 and product visualizations 462, 464, 466 corresponding to the products generated in the virtual scene.

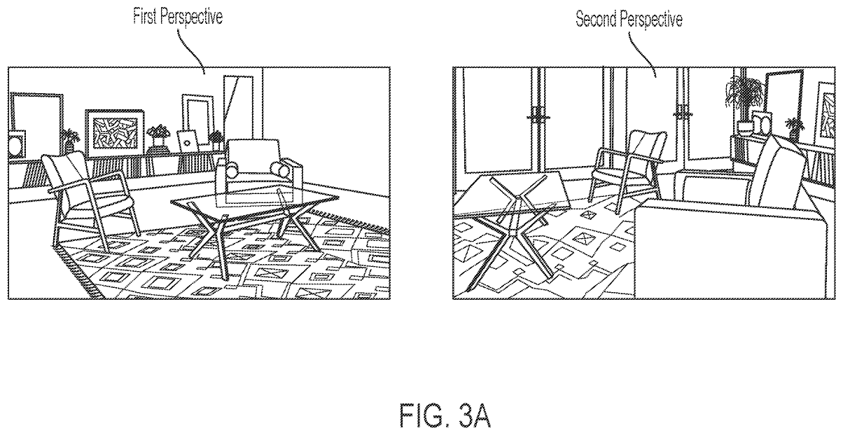

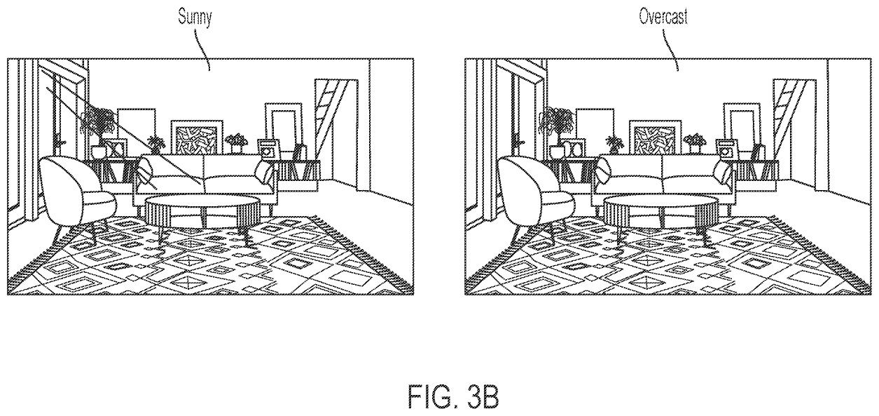

In some embodiments, in addition to physical objects that represent products, physical objects that enable control of certain aspects of the virtual scene may be placed on the translucent surface 112. For example, a camera card may be used that controls a perspective or location from which the virtual scene is viewed. The camera card may have an image of a camera thereon. As another example, a lighting card may be used that controls a lighting condition for the virtual scene (e.g., sunny, overcast, or nighttime). These additional physical objects also include markers on their respective surfaces. For example, a camera card may be placed on the translucent surface and enables a furniture arrangement in the virtual scene to be viewed from a location corresponding to the pose of the camera card determined from a marker provided on the camera card. FIG. 3A shows visualizations of products in a virtual scene from two different perspectives controlled using poses of a camera card. As another example, a lighting card may be placed on the translucent surface and enables a furniture arrangement in the virtual scene to be viewed in a particular lighting condition (e.g., overcast, sunny, night) corresponding to the marker identifier of the marker provided on the lighting card. FIG. 3B shows visualizations of products in a virtual scene under different lighting conditions (sunny versus overcast) controlled using corresponding lighting cards.

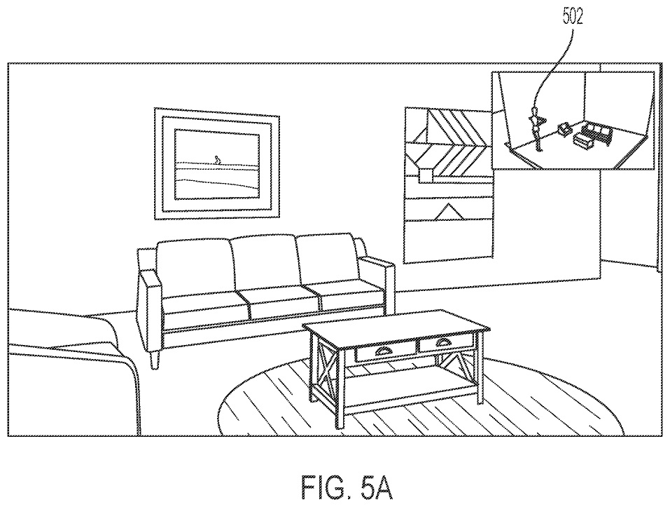

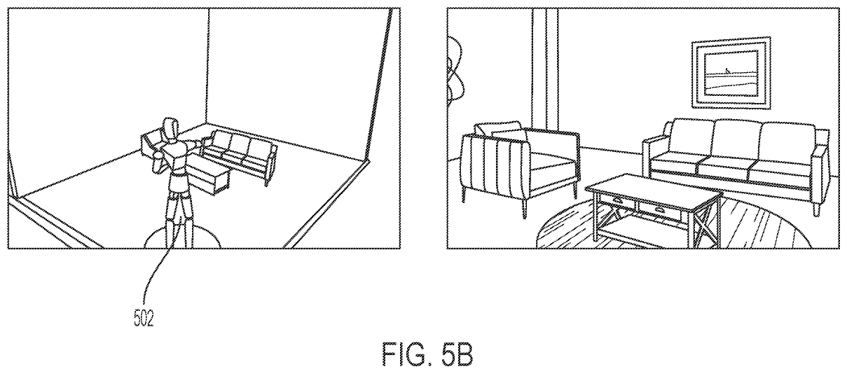

Other types of physical objects (other than cards) that enable control of aspects of the virtual scene may be used without departing from the scope of this disclosure. For example, FIGS. 5A-5B show visualizations of products in a virtual scene from different perspectives controlled using poses of a physical object 502 placed on a translucent surface, where the poses are determined using a marker provided on a bottom surface of the physical object 502.

In this way, the system developed by the inventors has several applications that assist non-expert customers in their purchase decision including: 1) visualizing products that are not on display in the brick-and-mortar store (e.g., due to stock-outs or lack of floor space for the full catalog), 2) comparing similar products or products of the same category that the customer is choosing between side-by-side (e.g., comparing accent chairs); and 3) exploring groups of complementary products that are to be purchased together to ensure compatibility (e.g., a living room set consisting of a sofa, a coffee table, and an accent chair); compatibility can include style considerations, but also physical attributes such as seat height or table top thickness. In addition, customers can use the camera card to view furniture arrangements from different locations within the scene. Due to high quality renders, the camera card can also be used to zoom in and visualize details of products, including materials (walnut versus oak, or wool versus leather) and the texture of surfaces, such as textiles and wood grain. Customers can use the lighting cards to switch between different lighting conditions (overcast versus sunny versus night).

The system developed by the inventors allows for a real-time ray traced experience for visualization of a room remodel. In one embodiment, the room remodel involves furniture selection or furniture arrangement. A customer's selection or manipulation of physical objects on a sensing platform causes an updated visualization of the products represented by the physical objects to be generated and included in a virtual scene. A display device displays the virtual scene which includes virtual product arrangements at life-size in real-time and at photorealistic quality. In some embodiments, the size of the display device may be 12×7 ft, 8×10 ft, or any other suitable size. In some embodiments, the display device may be a 4K resolution display or any other suitable display.

An example scenario where a customer may browse through products using the system 100 in a brick-and-mortar store is described as follows. A customer may begin browsing by placing a first physical object representing a sofa, or a model of a sofa, on the translucent surface of the sensing platform and the life-size display renders a photorealistic representation of the sofa at the corresponding location in the virtual scene. By manipulating the first physical object on the translucent surface, the customer can see different photorealistic renders of the sofa in different orientations in the virtual scene. The customer now wants to view an alternative to this sofa. To do so, the customer may select a second physical object (representing an alternate sofa) different than the previously selected first physical object and add it to the translucent surface. The customer is happy with the alternate sofa and not wants to shop for a coffee table to go with it. The customer picks a physical object representing a coffee table (from a set of physical objects) and adds it to the translucent surface. Next, the customer wants to complete the living room set by finding an accompanying accent chair. The customer wants to view some options for accent chairs. The customer removes the physical objects representing the coffee table and the sofa from the translucent surface and adds three physical objects that represent accent chairs to the translucent surface. Now the customer can compare the three chairs side by side on the life-size display. After picking a sofa, table, and chair, the customer wants to see how this final arrangement looks. In addition to placing the physical objects representing the products on the translucent surface, the customer adds a physical object (e.g., a camera card) that allows the customer to view the arrangement from different locations in the virtual scene and/or a physical object that controls lighting (e.g., a lighting card). In this way, the system developed by the inventors is a valuable tool that can help customers choose furniture that isn't physically available in the store by creating life-size, photorealistic visualizations by physically manipulating the physical objects on a sensing platform in real-time.

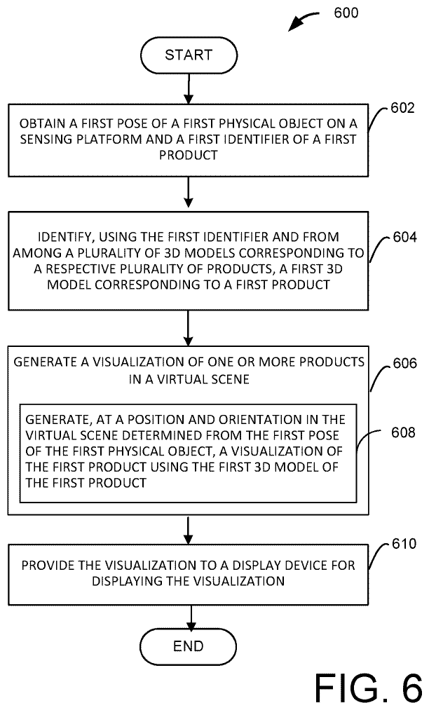

FIG. 6 shows an example process 600 for visualizing one or more products in a virtual scene, the one or more products including a first product. The process 600 may be performed using a computing device such as a server computing device described above with reference to FIG. 1. As shown in FIG. 6, the process 600 comprises an act 602 of obtaining, from a sensing platform having positioned thereon a first physical object representing the first product, a first pose of the first physical object on the sensing platform and a first identifier of the first product; an act 604 of identifying, using the first identifier and from among a plurality of three-dimensional (3D) models corresponding to a respective plurality of products, a first 3D model corresponding to the first product; an act 606 of generating a visualization of the one or more products in the virtual scene; an act 608 of generating, at a position and orientation in the virtual scene determined from the first pose of the first physical object, a visualization of the first product using the first 3D model of the first product; and an act 610 of providing the visualization to a display device for displaying the visualization.

One or more physical objects representing respective one or more products may be positioned on a sensing platform 110. For example, product cards 202, 204, 206 may be placed on a translucent surface 112 of the sensing platform. Each physical object has a marker on its surface identifying the product represented by the physical object. Markers on the surfaces of the physical objects are detected by the sensing platform. Poses of the physical objects and the product identifiers are determined using the markers.

In act 602, a first pose of a first physical object on the sensing platform and a first identifier of the first product are obtained from the sensing platform. For example, a pose of product card 202 and an identifier of the product represented by the product card 202 may be obtained.

In act 604, a first 3D model corresponding to the first product may be identified. In some embodiments, the first 3D model corresponding to the first product may be identified using the first identifier. The first 3D model corresponding to the first product may be identified from among a plurality of 3D models corresponding to a respective plurality of products, for example, from among several 3D models stored in the product database 140.

In act 606, a visualization of the one or more products in the virtual scene may be generated. In some embodiments, generating the visualization may include generating the visualization of the first product in the virtual scene based on the pose of the first physical object representing the first product. In act 608, a visualization of the first product may be generated using the first 3D model of the first product. The visualization of the first product may be generated at a position and orientation in the virtual scene determined from the first pose of the first physical object.

In act 610, the generated visualization of the product(s) in the virtual scene may be provided to a display device 130 for displaying the visualization. In some embodiments, the generated visualization of the product(s) in the virtual scene may be rendered using a ray tracing technique to provide a photorealistic visualization.

It should be appreciated that, although in some embodiments a sensing platform may be used to sense the position and/or orientation of one or more physical objects to facilitate generating a visualization of one or more products in a virtual scene, in other embodiments, a sensing platform may be replaced (or augmented) by a touch-based interface (e.g., a touch screen on any suitable type of computing device such as a tablet, a laptop, etc.). A user may drag and drop images and/or other virtual objects (rather than physical objects) representing products onto a graphical user interface (GUI) displayed by the touch-based interface. The user may select the virtual objects in a virtual catalog of products made available via the GUI. The user may place the virtual objects at positions and orientations indicative of the desired positions and orientations of the products in the virtual scene. In this way, in some embodiments, virtual objects may be used as proxies for the products instead of physical objects. In some embodiments, a hybrid system may be provided and may allow for a combination of one or more physical objects and one or more virtual objects to be used to provide information about desired positions and orientations of the products in the virtual scene. Such a hybrid system may include a touch screen for placement of virtual objects and a surface (e.g., a surface separate from the touch screen, the surface is the touch screen) on which physical objects may be placed and whose positions and orientations may be detected by one or more sensors (e.g., a camera or other imaging device) part of the hybrid system.

### Example Computing Device

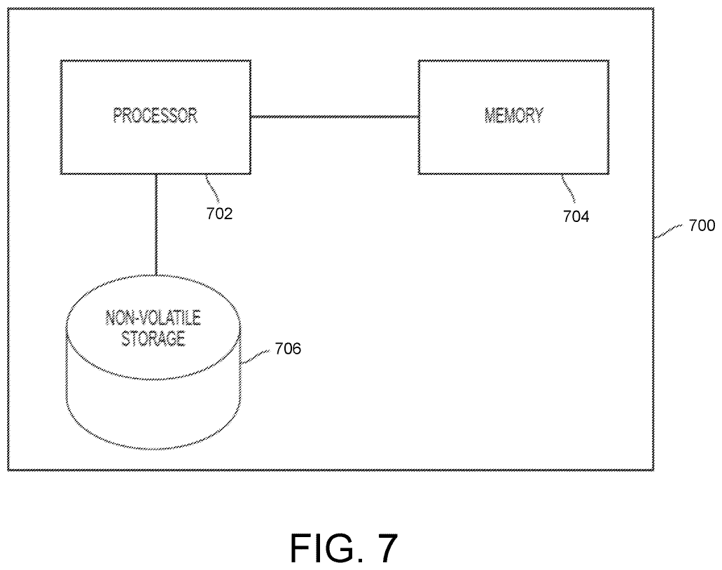

An illustrative implementation of a computing device 700 that may be used in connection with any of the embodiments of the disclosure provided herein is shown in FIG. 7. The computing device 700 may include one or more computer hardware processors 702 and one or more articles of manufacture that comprise non-transitory computer-readable storage media (e.g., memory 704 and one or more non-volatile storage devices 706). The processor 702(s) may control writing data to and reading data from the memory 704 and the non-volatile storage device(s) 706 in any suitable manner. To perform any of the functionality described herein, the processor(s) 702 may execute one or more processor-executable instructions stored in one or more non-transitory computer-readable storage media (e.g., the memory 704), which may serve as non-transitory computer-readable storage media storing processor-executable instructions for execution by the processor(s) 702.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A method for visualizing one or more products in a virtual scene, the one or more products including a first product, the method comprising:
using at least one computer hardware processor to perform:
obtaining, from a sensing platform having positioned thereon a first physical object representing the first product, a first pose of the first physical object on the sensing platform and a first identifier of the first product;
identifying, using the first identifier and from among a plurality of three-dimensional (3D) models corresponding to a respective plurality of products, a first 3D model corresponding to the first product;
generating a visualization of the one or more products in the virtual scene at least in part by:
generating, at a position and orientation in the virtual scene determined from the first pose of the first physical object, a visualization of the first product using the first 3D model of the first product; and
providing the visualization to a display device for displaying the visualization.

2. The method of claim 1, wherein the first physical object has a marker on its surface, the method further comprising:
detecting the marker on the surface of the first physical object; and
determining, using the marker, the first pose of the first physical object and the first identifier of the first product.

3. The method of claim 1, wherein the one or more products comprise multiple products, the multiple products including the first product, the method comprising:
obtaining, from the sensing platform having positioned thereon multiple physical objects representing the multiple products, poses of the physical objects on the sensing platform and identifiers of the multiple products, the poses including the first pose of the first physical object and the identifiers including the first identifier of the first product;
identifying 3D models of the multiple products using the identifiers; and
generating the visualization of the one or more products in the virtual scene at least in part by generating, at positions and orientations in the virtual scene determined from the poses of the physical objects, visualizations of the multiple products using the 3D models of the multiple products.

4. The method of claim 3, further comprising:
detecting markers on surfaces of the physical objects; and
determining, using the markers, the poses of the physical objects on the sensing platform and the identifiers of the multiple products.

5. The method of claim 2, wherein the first marker comprises an ArUco marker and/or QR code.

6. The method of claim 1, further comprising:
displaying the generated visualization of the one or more products in the virtual scene using the display device.

7. The method of claim 1, wherein the first physical object is a physical 3D model of the first product.

8. The method of claim 1, wherein the first physical object has an image of the first product thereon.

9. The method of claim 8, wherein the first physical object is a card or a swatch of material.

10. The method of claim 1, wherein the first product comprises furniture or art.

11. The method of claim 1, further comprising:
rendering the generated visualization of the one or more products in the virtual scene using a ray tracing technique.

12. A system for visualizing one or more products in a virtual scene, the one or more products including a first product, the system comprising:
at least one computer hardware processor; and
at least one non-transitory computer-readable storage medium storing processor executable instructions that, when executed by the at least one computer hardware processor, cause the at least one computer hardware processor to perform a method for visualizing one or more products in a virtual scene, the one or more products including a first product, the method comprising:
obtaining, from a sensing platform having positioned thereon a first physical object representing the first product, a first pose of the first physical object on the sensing platform and a first identifier of the first product;
identifying, using the first identifier and from among a plurality of three-dimensional (3D) models corresponding to a respective plurality of products, a first 3D model corresponding to the first product;
generating a visualization of the one or more products in the virtual scene at least in part by:
generating, at a position and orientation in the virtual scene determined from the first pose of the first physical object, a visualization of the first product using the first 3D model of the first product; and
providing the visualization to a display device for displaying the visualization.

13. (canceled)

14. A system for visualizing one or more products in a virtual scene, the one or more products including a first product, the system comprising:
a sensing platform having positioned thereon a first physical object representing the first product;
at least one computer hardware processor configured to:
obtain, from the sensing platform, a first pose of the first physical object on the sensing platform and a first identifier of the first product;
identify, using the first identifier and from among a plurality of three-dimensional (3D) models corresponding to a respective plurality of products, a first 3D model of the first product;
generate a visualization of the one or more products in the virtual scene at least in part by:
generating, at a position and orientation in the virtual scene determined from the first pose of the first physical object, a visualization of the first product using the first 3D model of the first product; and
provide the visualization to a display device; and
the display device configured to display the visualization.

15. The system of claim 14, wherein the sensing platform comprises:
a translucent surface on which the first physical object representing the first product is positioned; and
an imaging device placed in proximity to the translucent surface.

16. The system of claim 15, wherein:
the first physical object has a marker on its surface, and
the imaging device is configured to capture at least one image of the marker.

17. The system of claim 14, wherein the at least one computer hardware processor is part of the sensing platform.

18. The system of claim 14, wherein the at least one computer hardware processor is remote from the sensing platform.

19. The system of claim 14, wherein the first physical object is a physical 3D model of the first product, a card having an image of the first product thereon, or a swatch of a material having the image of the first product thereon.

20. The system of claim 14, wherein the display device comprises a projector and a screen.
